(19) United States
(12) Patent Application Publication
(10) Pub. No.: US 2008/0294283 A1
(43) Pub. Date: Nov. 27, 2008

(54) BATTERY EXCHANGE STATION AND A METHOD OF CHANGING THEREIN

(76) Inventor: Ronald Ligrano, Hollywood, CA (US)

Correspondence Address: Ron Ligrano, 8643 Hayden Place, Culver City, CA, 90232, US

(21) Appl. No.: 12/125,010

(22) Filed: May 21, 2008

Related U.S. Application Data
(60) Provisional application No. 60/931,597, filed on May 25, 2007.

(51) Int. Cl. G06F 17/00

(52) U.S. Cl. 700/218; 700/230

(57) ABSTRACT

An exchange station and method of changing is provided. The battery exchange station includes a controlled area, a receiving bay, a storage bay, a generating system, a mechanical positioning device, and a control system. The controlled area is comprised of an exchange opening. The storage bay is comprised of a charging storage rack and first and second replacement batteries. The mechanical positioning device is comprised of a base, a first and second connecting arms and a battery support connector. The control system is comprised of a stationary communication system and a mobile communication control system. The stationary communication system is comprised of a central processing unit, a plurality of sensors, and a plurality of guidance components.

### PRIORITY

This application claims priority to prior filed Provisional Patent Application No. 60/931,597

### BACKGROUND OF THE INVENTION

1) Field of the Invention

The invention relates to exchanging and maintaining batteries for electric cars.

2) Discussion of the Related Art

The gasoline-powered internal-combustion engine has dominated the transportation vehicle for most of the 20th century. Motor vehicles generate more air pollution than any other human-made machine. The toxic mixture of chemicals in the environment is also recognized as a major health hazard costing the United States $93 billion dollars in medical bills. Gasoline-powered vehicles contribute to the greenhouse effect, releasing chlorofluorocarbons, carbon dioxide, nitrous oxide, methane, carbon monoxide, and nitrogen oxides. When a single tank of gasoline is used, between 300 and 400 pounds of carbon dioxide is formed. A variety of vehicles and fuels are now becoming available to serve as alternatives to gasoline driven vehicles. Research projects are bringing to fruition, a set of vehicle technologies that are clean burning, highly efficient, and user friendly.

Some of the technology includes battery-powered, fuel cell, and hybrid-electric vehicles. These forms of power reduce fossil fuel consumption and mitigate harmful effects on the atmosphere, effectively increasing air quality and human health. Moreover, these vehicles are highly efficient and in most cases produce zero emissions. The battery-powered vehicles use chemical batteries to store electricity for the vehicle. And the hybrid and fuel cell powered vehicles generate electricity for the car while driving.

Hybrid-electric vehicles are beneficial because they are not limited in range, in that the vehicle can be filled up at any gasoline station. Hybrids never need to be plugged in to an electrical source. Recharging the battery occurs during normal driving conditions. During braking and coasting the forward energy is converted into electricity to charge the batteries. Also, depending on the type of hybrid, the gasoline engine can either directly or indirectly charge the batteries when needed. The downside to said vehicles is the pollution associated with its manufacturing, namely, the creation of two motors instead of one. Moreover, the vehicle is dependent on petroleum, thus continuing to exacerbate current environmental conditions.

The battery-powered vehicle is the environmentally safe alternative. It produces zero emissions, lessening the greenhouse effect, and reduces dependency on fossil fuels. The battery-powered vehicle, compared to other alternatives, runs completely silent. Several states have understood the benefits of these vehicles and now mandate the sales of “zero emissions” vehicles to improve local air quality.

The battery-powered vehicle is not without problems. The vehicle is limited in range and by the amount of time spent to recharge the battery. A battery-powered vehicle can travel 70-80 miles before it must be recharged and it can take hours to recharge a battery after depletion. Hence, a need exists in the art to expand the range of the battery-powered vehicle and decrease the waiting time for a recharge of a depleted battery.

### BRIEF DESCRIPTION OF THE DRAWINGS

The invention is described by way of example with reference to the accompanying drawings wherein:

FIG. 1 is a perspective view of a battery exchange station.

FIG. 2 is a top perspective view of a control system of the battery exchange station.

FIG. 3 is a top perspective view of the control system wirelessly communicating and controlling a vehicle autonomously.

FIG. 4 is a top perspective view of the control system, wirelessly controlling and positioning the vehicle for a battery exchange.

FIG. 5 is a top perspective view of the control system, wirelessly releasing vehicle autonomy.

FIG. 6 is a side view of a mechanical positioning device exchanging a battery from the vehicle.

FIG. 7 is a frontal view of the mechanical positioning device contacting the battery of the vehicle.

FIG. 8 is a bottom view of a plurality of battery connection ports of the battery.

### DETAILED DESCRIPTION OF THE INVENTION

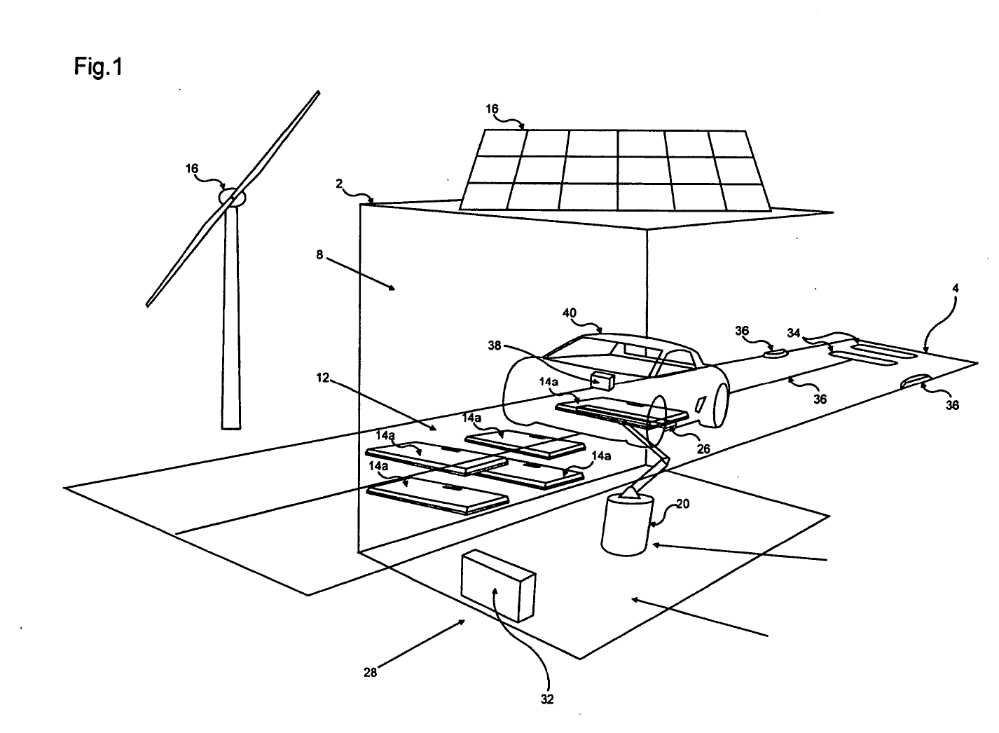

FIG. 1 of the accompanying drawings illustrates a battery exchange station 2, which includes a controlled area 4, a receiving bay 8, a storage bay 10, a generating system 16, a mechanical positioning device 18, and a control system 28.

The storage bay 10 is comprised of a charging storage rack 12, a first charged battery 14a and a second charged battery 14b. The generating system 16, in one embodiment is comprised of a plurality of solar panels, and in another embodiment, the generating system is comprised of a wind turbine or other generator equivalent.

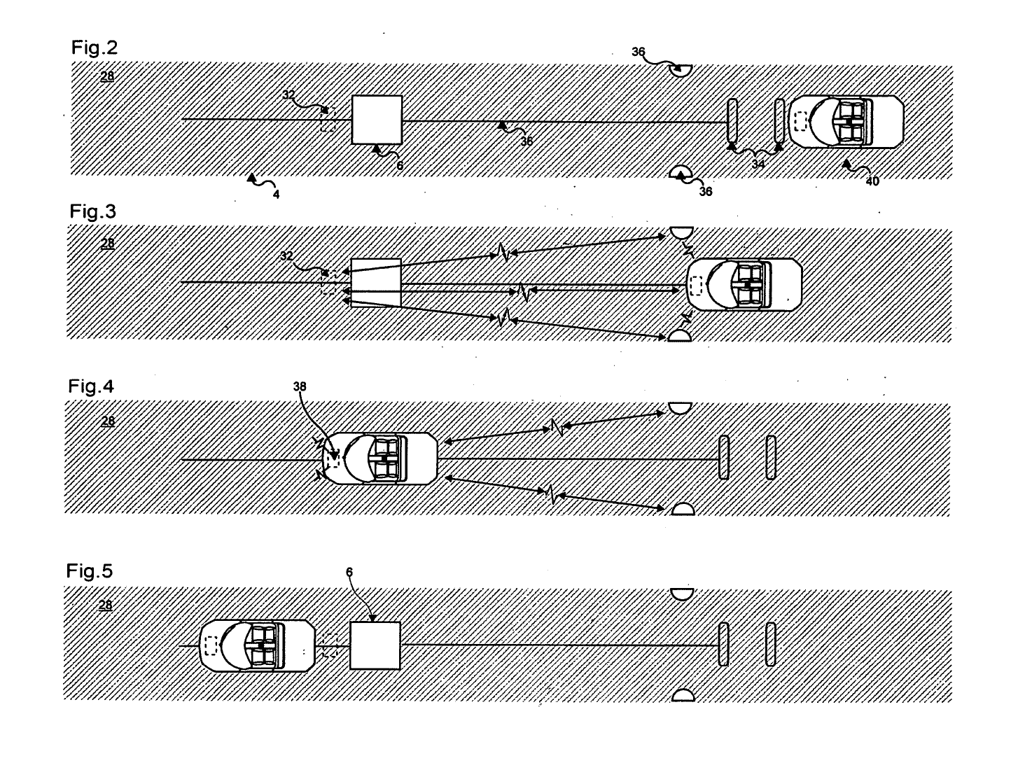

FIG. 2 illustrates the control system 28 and controlled area 4, in detail. The controlled area 4 is comprised of an exchange opening 6. The control system 28 is comprised of a stationary communication system 30 and a mobile communication control system 38. The stationary communication system 30 is comprised of a central processing unit 32, a plurality of sensors 34 and a plurality of guidance components 36.

FIG. 3 illustrates the activation of the control system 28. An operator driving an electric vehicle 40 activates the plurality of sensors 34 by positioning over the plurality of sensors 34. The plurality of sensors 34 activate the stationary communication system 30 and wirelessly connect to the mobile control system 38 within the vehicle 40, activating it, wirelessly connecting the vehicle 40 to the central processing unit 32 of the stationary communication system 30. The central processing unit 32, of the stationary communication system 30 wirelessly connects to the plurality of guidance components 36. The control system 28, wirelessly controlling the vehicle 40, renders it autonomous.

FIG. 4 illustrates the control system 28 controlling the vehicle 40 over the exchange opening 6 of the controlled area 4. The stationary communication system 30 and the mobile communication control system 38 wirelessly communicate, determining a position of the vehicle 40 relative to the exchange opening 6. The mobile communication control system 38 controls the vehicle 40 functionality and responds to the stationary communication system 30 determination of the position of the vehicle 40, guiding the vehicle 40 over the exchange opening 6.

FIG. 5 illustrates the control system 28 releasing wireless control of the vehicle 40 after positioning over the exchange opening 6 and a subsequent battery exchange. The stationary communication system 30, wirelessly connected, with the mobile communication control system 38, signals a release of autonomous control, allowing the vehicle 40 to be controlled by the operator.

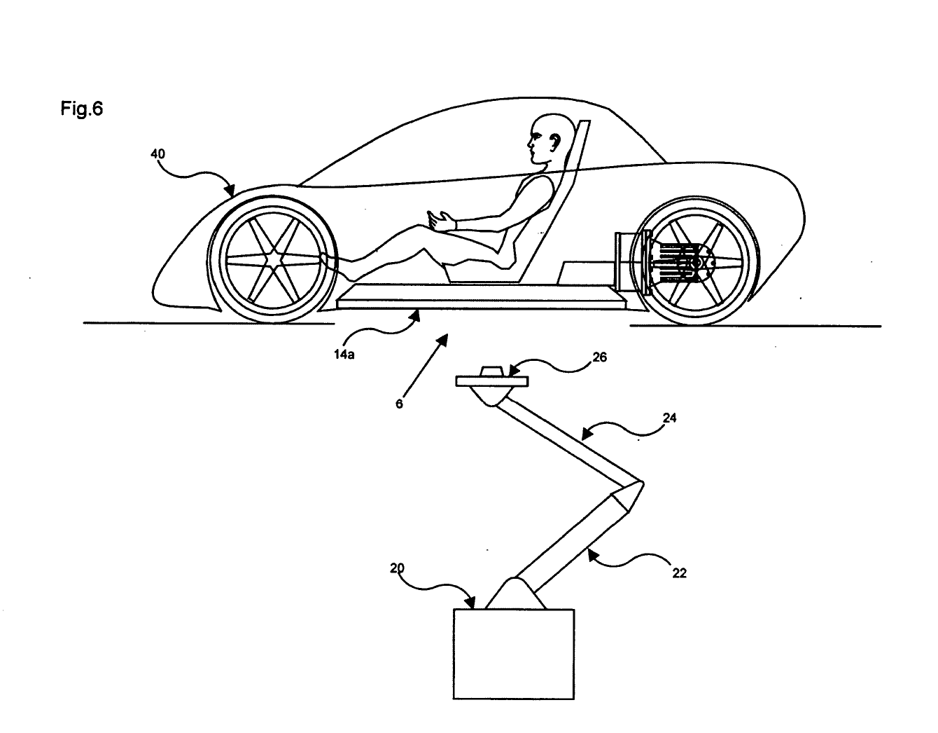

FIG. 6 illustrates the battery exchange in more detail, once the vehicle 40 is positioned over the exchange opening 6 of the controlled area 4, which includes the mechanical positioning device 18. The mechanical positioning device 18 is comprised of a base 20, a first and a second connecting arm, 22 and 24, respectfully, and a battery support connector 26.

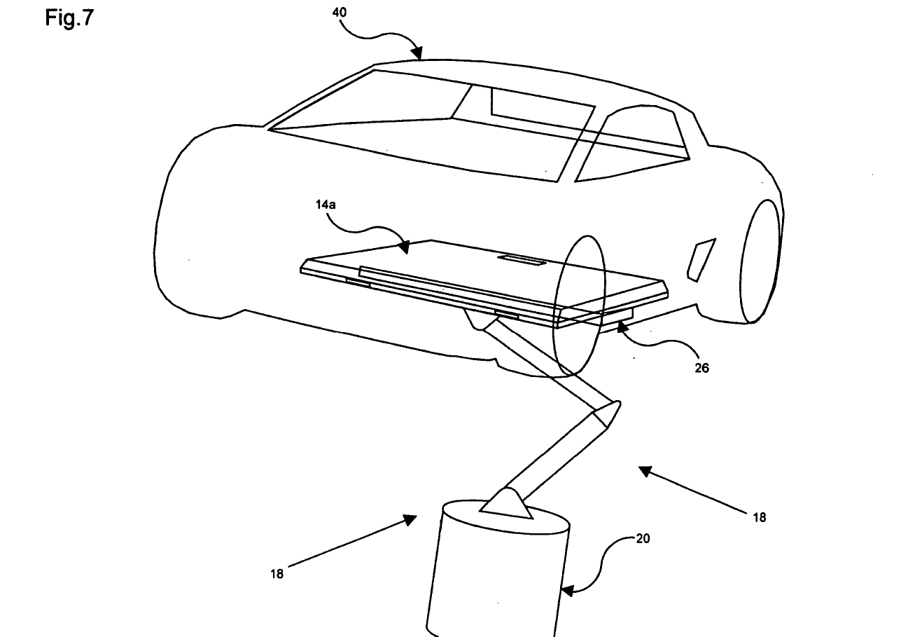

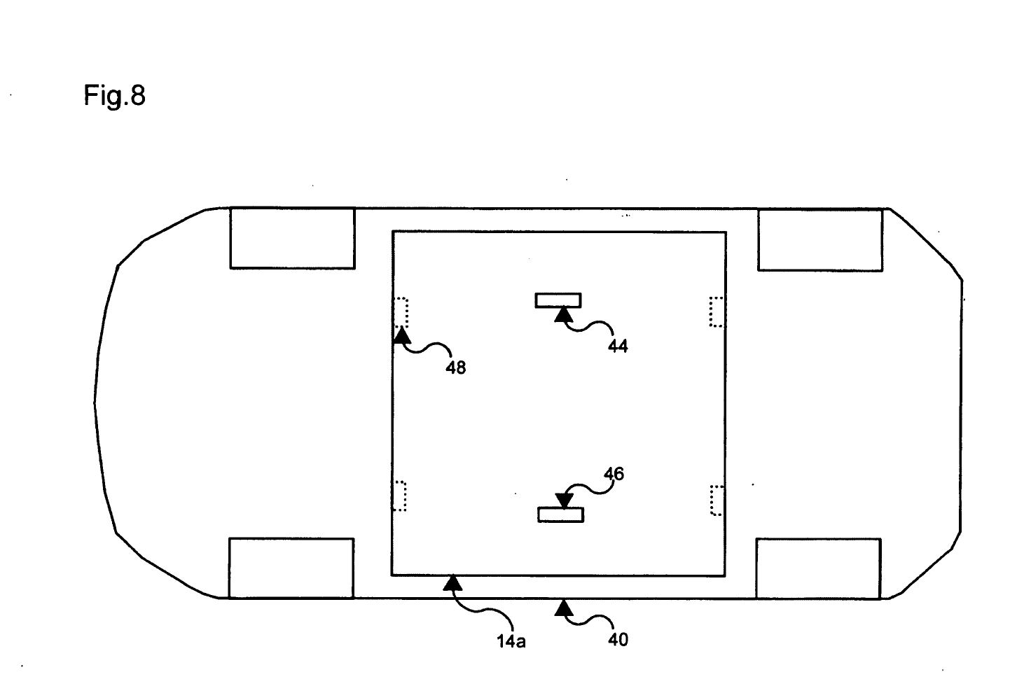

FIG. 7 illustrates the connection of the mechanical positioning device 18 to the battery 14a. FIG. 8 illustrates first and second battery lock ports, 44 and 46, respectively, of the battery 14a, and a plurality of auto-locking members 48.

In use, the battery exchange station 2, including the controlled area 4, the receiving bay 8, the storage bay 10, the generating system 16, the mechanical positioning device 18 and the control system 28, receives the vehicle 40 into the receiving bay 8 to exchange the first charged battery 14a. The vehicle 40 is controlled by the control system 28, which is comprised of the stationary communication system 30 and the mobile communication control system 38. The stationary communication system 30 is comprised of the central processing unit 32, plurality of sensors 34, and the plurality of guidance components 36, which control the area in and around the battery exchange station 2. In one embodiment, the stationary communication system 30 and the mobile communication control system 38 are comprised of substantially similar components.

The vehicle 40, controlled by an operator, activates the control system 28, after positioning over the plurality of sensors 34. The plurality of sensors 34, activate the stationary communication system and wirelessly connect to the mobile control system 38 within the vehicle 40, activating it, wirelessly connecting the vehicle 40 to the central processing unit 32 of the stationary communication system 30. The central processing unit 32 wirelessly connects to the guidance components 36, rendering the vehicle 40 autonomous. The mobile control system 38 wirelessly transfers vehicle information to the central processing unit 32. In one embodiment, the plurality of sensors 34, the mobile control system 38 and the central processing unit communicate via Bluetooth™ wireless protocol.

The central processing unit 32 wirelessly connects to the plurality of guidance components 36 and to the mobile control system 38. In one embodiment, the guidance components can be laser, radar and/or infrared sensors. The mobile communication control system 38, responding to the stationary communication system 30 location coordinates of the vehicle 40, controls the vehicle functionality. In one embodiment, the laser and radar sensors communicate to a bus interface, connected to a drive-by-wire system, controlling the throttle, braking and steering of the vehicle 40, including a proportional integral device within the mobile communication control system 38. In another embodiment, the mobile communication control 38 contains sensors.

The stationary communication system 30 and the mobile communication control system 38 wirelessly communicate, determining a position of the vehicle 40 relative to the exchange opening 6. The control system 28 positions the vehicle 40 over the exchange opening 6 of the controlled area 4 for battery exchange. The central processing unit 32 communicates to the mechanical positioning device 18 to contact the first and second battery lock ports, 44 and 46, respectively, of the battery 14a of the vehicle 40 for removal.

In one embodiment, the stationary communication system 30 wirelessly communicates to the mobile control system 38, to unlock the plurality of auto-locking members 48 of the battery 14a when the mechanical positioning device 18 contacts the first 44 and second 46 battery lock ports. In another embodiment, the mechanical positioning device 18 contacts and turns the first and second battery lock ports, 44 and 46, respectively, unlocking the battery 14a.

The mechanical positioning device 18 delivers the battery 14a to the charging storage rack 12, of the storage bay 10 to charge. The generating system 16, in one embodiment is comprised of a plurality of solar panels, and in another embodiment, the generating system 16 is comprised of a wind turbine, serving to recharge battery 14a, rendering the battery exchange station 2 self-sufficient and electrically self-containing. The generating system 16, in another embodiment, is any natural or gas powered generator.

The mechanical positioning device 18 contacts a second battery 14b on the charging storage rack 12. The mechanical positioning device 18 contacts the first and second battery lock ports, 44 and 46, respectively, and inserts the charged battery 14b into vehicle 40. In one embodiment, the stationary communication system 30 wirelessly communicates to the mobile control system 38, to lock the plurality of auto-locking members 48 of the battery 14a when the mechanical positioning device 18, contacting the first 44 and second 46 battery lock ports, positions the second battery 14b in the vehicle 40. In another embodiment, the mechanical positioning device 18 contacts and turns the first and second battery lock ports, 44 and 46, respectively, locking the battery 14a into the vehicle 40.

The mechanical positioning device 18 retracts, allowing the vehicle 40 to be guided by the control system 28. In one embodiment, the mechanical positioning device is an autonomous robot and can be electronic, hydraulic or pneumatic. The control system 28 then controls the vehicle 40 out of the receiving bay 8. The stationary communication system 30 wirelessly connected to the mobile communication control system 38, signals a release of the autonomous control of the vehicle 40 back to the operator.

The battery-powered vehicle is limited in range and also by the amount of time spent in recharging the battery. The battery exchange station 2 provides an effective environmental solution. The battery exchange station 2 increases the range of battery-powered cars by the amount of locations for battery exchange. Moreover, the amount of time spent is one of exchange, not recharge, allowing the electric vehicle 40 to operate on an exchanged fully recharged battery in less than sixty seconds from entry.

The wireless environment of the battery exchange station 2 provides a more accurate battery exchange, reducing human-error and accidents. Wireless control eliminates machinery involved in the battery exchange that would otherwise be created, reducing the amount by-products released into the atmosphere. The wireless environment also conserves energy because it requires reduced power in which to operate, effectively allowing a generating system 16 to provide the necessary power to keep the battery exchange station 2 self-sustainable.

While certain exemplary embodiments have been described and shown in the accompanying drawings, it is to be understood that such embodiments are merely illustrative and not restrictive of the current invention, and that this invention is not restricted to the specific constructions and arrangements shown and described since modification may occur to those ordinarily skilled in the art.

What is claimed:

1. An exchange station for exchanging replaceable elements on a vehicle, comprising:
a controlled area including a receiving bay for the vehicle with a first replaceable element;
a storage bay for at least one replaceable element;
a control system for controlling the vehicle within the controlled area, including a stationary communication system comprising a central processing unit, memory, and a computer readable medium providing a set of instructions for coordinating at least one direction of the vehicle, a plurality of sensors, and a plurality of guidance components, communicating within the control system and to a mobile communication control system of the vehicle, guiding the vehicle for exchange; and
a mechanical positioning device including a first and a second connecting arm, and a support connector, the support connector contacting the first replaceable element on the vehicle, exchanging the first replaceable element for a second replaceable element from the storage bay, wherein the control system guides the vehicle from the controlled area, releasing control.

2. The exchange station of claim 1 wherein the controlled area includes an exchange opening in which to exchange replaceable elements.

3. The exchange station of claim 1 wherein the replaceable element is a rechargeable battery.

4. The exchange station of claim 3 including a charging rack for recharging rechargeable batteries.

5. The exchange station of claim 3 wherein the support connector is a battery support connector configured to connect to rechargeable batteries.

6. The exchange station of claim 1 wherein the mechanical positioning device is an autonomous robot.

7. The exchange station of claim 1 wherein the mechanical positioning device is hydraulic.

8. The exchange station of claim 1 wherein the plurality of sensors, the guidance components, the mobile and stationary control systems communicate via Bluetooth™ wireless protocol.

9. The exchange station of claim 1 wherein the guidance components are laser sensors.

10. The exchange station of claim 1 wherein the guidance components are radar sensors.

11. The exchange station of claim 1 wherein the guidance components are infrared sensors.

12. The exchange station of claim 1 wherein the mobile control system communicates a signal to drive-by-wire system within the vehicle.

13. The exchange station of claim 1 including a generating system, generating power to the exchange station.

14. The exchange station of claim 13 wherein the generating system is a plurality of solar panels.

15. The exchange station of claim 13 wherein the generating system is a wind turbine.

16. A method of exchanging replaceable elements on a vehicle in an exchange station, comprising:
receiving a vehicle with a first replaceable element in a controlled area including a receiving bay, the exchange station including a storage bay with a rack for at least one replaceable element;
controlling the vehicle with a control system, the control system including a stationary communication system comprising a central processing unit, memory, and a computer readable medium providing a set of instructions for coordinating at least one direction of the vehicle, a plurality of sensors, and a plurality of guidance components, communicating with the control system and to a mobile communication control system of the vehicle, guiding the vehicle within the controlled area for exchange; and
exchanging the first replaceable element with a second replaceable element, with a mechanical positioning device, the mechanical positioning device including a first and a second connecting arm, and a support connector, the support connector contacting the first replaceable element, placing the first replaceable element on the rack, and retrieving the second replaceable element, wherein the control system guides the vehicle out of the controlled area, releasing control.

17. The method of exchanging of claim 16 wherein the controlled area includes an exchange opening.

18. The method of exchanging of claim 16 wherein the replaceable element is a rechargeable battery.

19. The method of exchanging of claim 18 wherein the rack is a recharging rack.

20. The method of exchanging of claim 16 including a generating system, generating power to the exchange station.
